(19) United States
(12) Patent Application Publication
(10) Pub. No.: US 2007/0290856 A1
(43) Pub. Date: Dec. 20, 2007

(54) RFID tag detuning

(75) Inventor: Philippe Martin, Beaune (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Tagsys SAS, La Penne-Sur Huveaune (FR)

(21) Appl. No.: 11/805,254

(22) Filed: May 22, 2007

Related U.S. Application Data
(60) Provisional application No. 60/814,788, filed on Jun. 19, 2006.

(51) Int. Cl. G08B 13/14

(52) U.S. Cl. 340/572.3; 340/572.7

(57) ABSTRACT

An RFID tag is disclosed comprising at least one antenna and a detuning loop including an open circuit electromagnetically coupled to the antenna. The RFID tag also comprises means for closing the open circuit. The tag is arranged such that when the circuit is closed the loop detunes the tag sufficiently to prevent it from being read. A method of detuning an RFID tag is also disclosed.

### CROSS-REFERENCE TO RELATED APPLICATIONS

This application claims the benefit of the filing date of U.S. Provisional Patent Application No. 60/814,788 filed Jun. 19, 006, the disclosure of which is hereby incorporated herein by reference.

### FIELD OF THE INVENTION

The present invention relates to RFID tags. In particular the invention relates to a detuning loop for an RFID tag that may be used to detune the RFID tag sufficiently to prevent it from being read. The detuning loop may be arranged such that a detuned tag may be subsequently retuned.

### BACKGROUND OF THE INVENTION

The RFID tags may form part of an object management system wherein information bearing electronically coded RFID tags are attached to objects which are to be identified, sorted, controlled and/or audited. The object management system may include information or data passing between an interrogator or reader and the electronically coded tags. The tags may respond by issuing a reply signal that is detected by the interrogator, decoded and subsequently supplied to other apparatus in the sorting, controlling or auditing process.

In some circumstances it is desirable to turn off or detune the tags to prevent the tags from being read. In other circumstances it is desirable to turn on or retune tags after they have been tuned on or detuned.

### SUMMARY OF THE INVENTION

According to one aspect of the present invention there is provided an RFID tag comprising:
at least one antenna;
a detuning loop including an open circuit electromagnetically coupled to said antenna; and
means for closing said open circuit, the tag being arranged such that when said circuit is closed said loop detunes the tag sufficiently to prevent it from being read.

The antenna and the detuning loop may be located on a common substrate. The detuning loop may surround the antenna. The antenna and detuning loop may be located on opposite sides of the substrate. The detuning loop may be open circuit in two places. The detuning loop may include a first switch for closing the open circuit to create a magnetic short. The first switch may be biased to an open position.

The RFID tag may include means for adjusting inductance of the antenna. The antenna may include a coil and the means for adjusting may include means for short circuiting at least some turns of the coil. The means for shorting may include a second switch for connecting a tap point on the coil to one end of the coil.

According to a still further aspect of the present invention there is provided an RFID tag comprising:
at least one antenna;
a detuning loop including a closed circuit electromagnetically coupled to said antenna such that said loop detunes the tag sufficiently to prevent it from being read; and
means for opening said closed circuit to retune the tag.

The circuit may include a switch biased to a closed position and the means for opening the circuit may include means for moving the switch to an open position.

According to a further aspect of the present invention there is provided a method of detuning an RFID tag, said tag including at least one antenna, said method comprising:
providing a detuning loop including an open circuit such that said loop is electromagnetically coupled to said antenna; and
closing said open circuit such that said loop detunes said tag sufficiently to prevent it from being read.

According to a still further aspect of the present invention there is provided a method of retuning an RFID tag, said tag including at least one antenna and a detuning loop including a closed circuit that is electromagnetically coupled to said antenna such that said loop detunes said tag sufficiently to prevent it from being read, said method comprising a step of opening said closed circuit to retune the tag.

The circuit may include a switch biased to a closed position and the step of opening the circuit may include moving the switch to an open position.

In a preferred embodiment tuning or detuning of a tag may be performed by manipulating a part of an object with which the tag is associated. For example a tag may be used in connection with an RFID tamper evidence cap for a container or vial. It may be desirable to detect when a container or vial in a large batch of such containers or vials has been tampered with. In one embodiment a tag may be detuned by moving an outer cap or closure associated with the vial or container relative to an inner cap or closure.

### BRIEF DESCRIPTION OF THE DRAWINGS

Preferred embodiments of the present invention will now be described with reference to the accompanying drawings wherein:

FIG. 1(a) shows a schematic diagram of an RFID tag in a tuned condition;

FIG. 1(b) shows a plan view of the RFID tag of FIG. 1(a);

FIG. 1(c) shows a cross sectional view of a switch associated with the RFID tag in FIGS. 1(a) and 1(b);

FIG. 2(a) shows a schematic diagram of an RFID tag in a detuned condition;

FIG. 2(b) shows a plan view of the RFID tag of FIG. 2(a);

FIG. 2(c) shows a cross sectional view of a switch associated with the RFID tag in FIGS. 2(a) and 2(b);

FIG. 3 shows a schematic diagram of another RFID tag in a tuned condition;

FIG. 4 shows a schematic diagram of the RFID tag of FIG. 3 in a detuned condition;

FIG. 5 shows an enlarged view of an RFID tag including details of an antenna and a detuning loop;

FIG. 6 shows switches associated with a detuning loop;

FIGS. 7(a) to 7(d) show an embodiment of the invention for detuning a tag;

FIGS. 8(a) to 8(d) show an embodiment of the invention for retuning a tag; and

FIGS. 9(a) to 9(b) show a further embodiment of the invention for detuning a tag.

### DETAILED DESCRIPTION

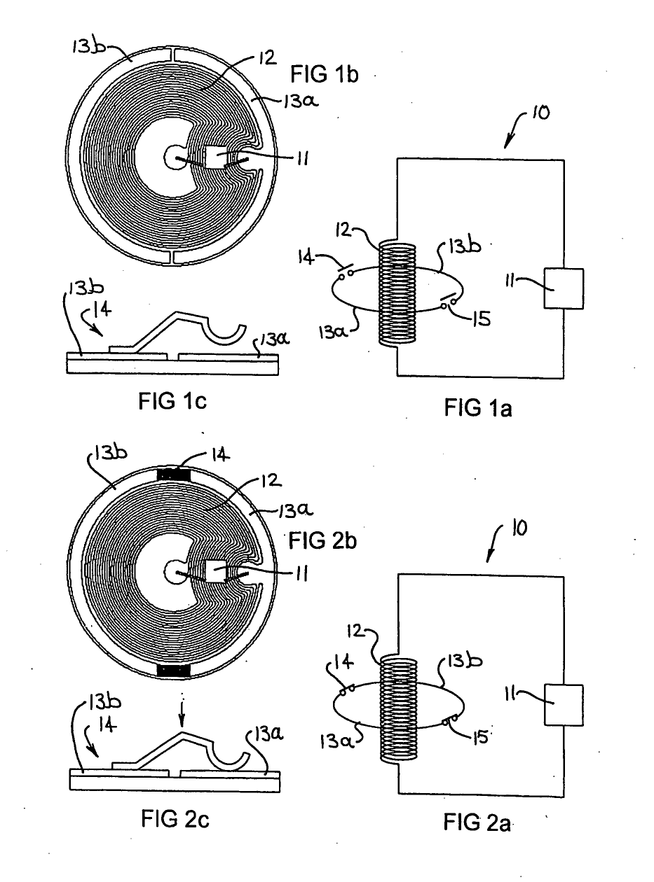

FIGS. 1(a) to (c) show an RFID tag 10 comprising chip 11 and antenna coil 12 in a tuned condition. In FIG. 1 RFID tag 10 is tuned to an operating frequency wherein the Q factor of a resonant circuit including antenna coil 12 is relatively high. The read range of RFID tag 10 in the tuned condition is relatively good. A detuning loop including semi-circular conductive segments 13a, 13b surrounds antenna coil 12. The detuning loop is adapted to detune the tag 10 when switches 14, 15 are closed.

FIGS. 2(a) to (c) show the RFID tag 10 of FIG. 1 in a detuned condition in which switches 14, 15 are closed. In the detuned condition loop 13 creates a magnetic short causing the Q factor of the resonant circuit to be relatively low. The read range of RFID tag 10 in the detuned condition is relatively poor. In the detuned condition the read range of RFID tag 10 may be sufficiently poor to prevent it from being read.

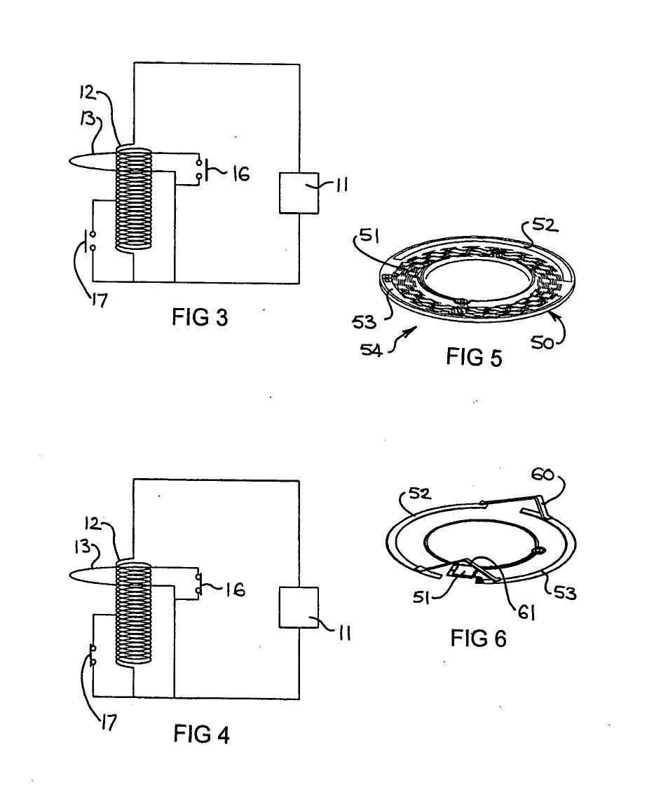

FIG. 3 shows an RFID tag that is similar to FIG. 1(a) but includes a modified detuning loop. In FIG. 3 the RFID tag is tuned to an operating frequency wherein the Q factor of a resonant circuit including antenna coil 12 is relatively high. The read range of the RFID tag in the tuned condition is relatively good. The modified detuning loop includes a penannular conductive segment 13 surrounding antenna coil 12. The detuning loop is adapted to detune the RFID tag when switch 16 is closed.

FIG. 4 shows the RFID tag of FIG. 3 in a detuned condition in which switch 16 is closed. In the detuned condition loop 13 creates a magnetic short causing the Q factor of the resonant circuit to be relatively low. The read range of RFID tag 10 in the detuned condition is relatively poor. To further remove the RFID tag from the read range of the interrogator, a switch 17 is connected between a tap point on antenna coil 12 and one end of antenna coil 12. Switch 17 is adapted to short circuit some turns of antenna coil 12. Short circuiting some turns of antenna coil 12 has an effect of decreasing inductance and increasing the frequency of the RFID tag thereby further removing the tag from the read range of the interrogator.

FIG. 5 shows an insulating substrate 50 such as a printed circuit board (PCB). One side (top) of the substrate contains components of an RFID transducer including RFID chip 51. The same side also contains a detuning loop including a pair of semi circular conductive segments 52, 53 adjacent the outer periphery of the substrate. The other side (underside) of the substrate contains antenna coil 54. A thru connection is provided in the insulating substrate 50 to facilitate connecting antenna coil 54 to RFID chip 51.

FIG. 6 shows details of switches associated with a detuning loop. The switches include conductive elements 60, 61 respectively. One end of element 60 is soldered to one end of conductive segment 53. The element 60 is bent in the shape of a V such that the free end points toward conductive segment 52 but is normally biased so that it does not make contact with conductive segment 52. One end of element 61 is soldered to one end of conductive segment 52. The element 61 is bent in the shape of a V such that the free end points toward conductive segment 53 but is normally biased so that it does not make contact with conductive segment 53. The switches may be moved to their closed positions by applying a force to the apex of the V shape of each conductive element. When both switches are moved to the closed positions the detuning loop is closed to create a magnetic short that detunes the tag and prevents it from being read.

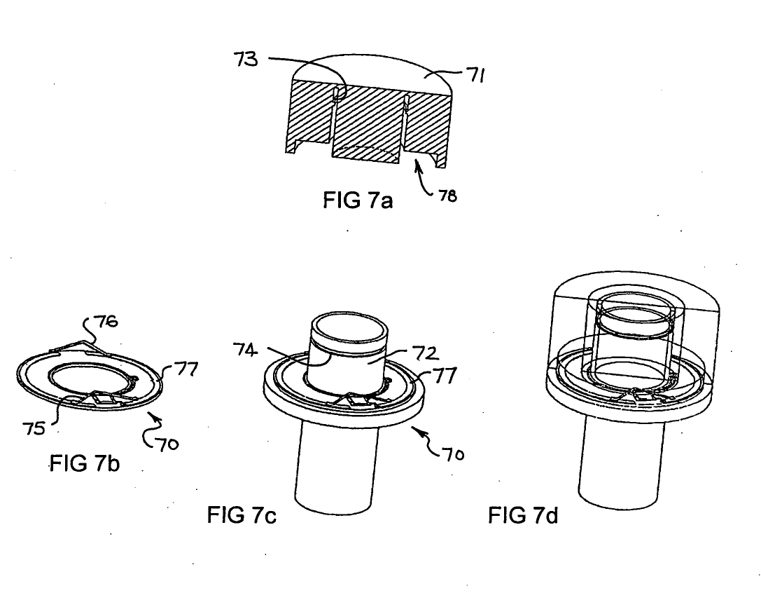

FIGS. 7(a) to 7(d) show an RFID tag 70 associated with an object including a first part 71 and a second part 72. The first part 71 includes a flange 73 that engages a groove 74 in second part 72 when parts 71 and 72 are put together as shown in FIG. 7(d). FIG. 7(b) shows switches 75, 76 in a standby or initial condition in which switches 75, 76 are open. In the open positions the free ends of switches 75, 76 do not make contact with the conductive segments of detuning loop 77. The standby or initial condition is associated with a correctly tuned tag 70 and with separated parts 71, 72. When parts 71, 72 are put together as shown in FIG. 7(d), an annular surface 78 associated with first part 71 presses against the apex of each switch 75, 76 causing the free ends of the switches to make contact with the conductive segments of the detuning loop 77. When both switches 75, 76 make contact with the segments of the detuning loop they create a magnetic short that detunes tag 70.

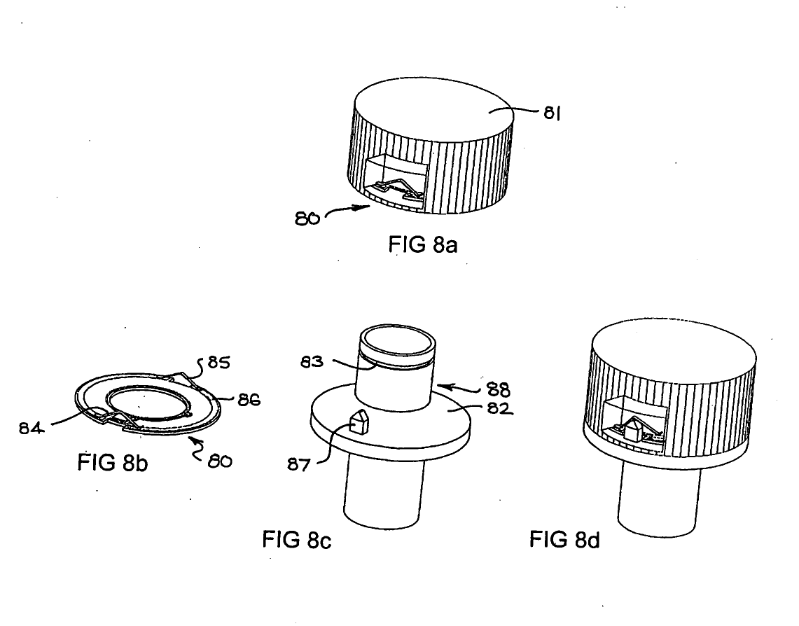

FIG. 8(a) to 8(d) show an RFID tag 80 associated with an object including a first part 81 and a second part 82. The first part 81 includes a flange (not shown) that engages a groove 83 in second part 82 when parts 81 and 82 are put together as shown in FIG. 8(d). FIG. 8(b) shows switches 84, 85 in a standby or initial condition in which switches 84, 85 are closed. In the closed positions, the free ends of switches 84, 85 make contact with the conductive segments of detuning loop 86. The standby or initial condition is associated with a detuned tag 80 and with separated parts 81, 82.

When parts 81, 82 are put together as shown in FIG. 8(d), projecting parts 87, 88 associated with second part 82, engage and push up against switches 84, 85 causing the free ends of the switches to break contact with the conductive segments of the detuning loop 86. When one or both switches 84, 85 break(s) contact with the conductive segments of the detuning loop 86 they also break a magnetic short that causes the tag 80 to be retuned.

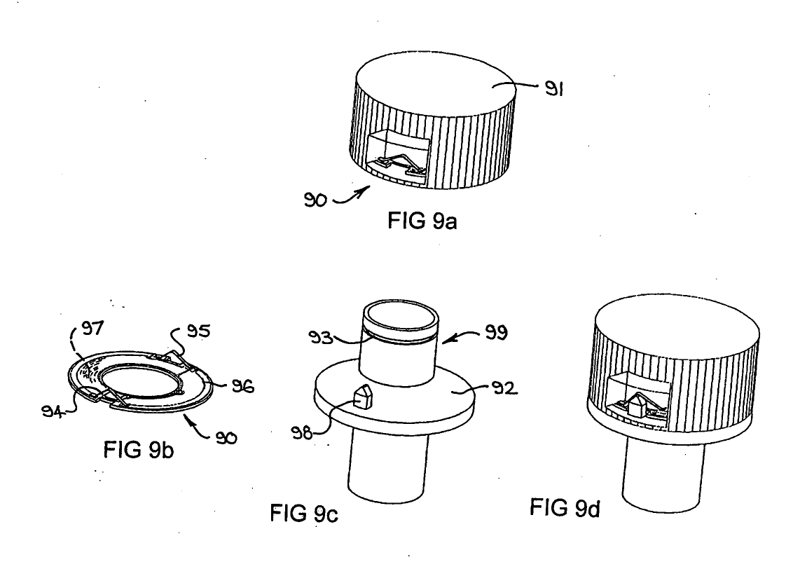

FIG. 9(a) to 9(d) shows an RFID tag 90 associated with an object including a first part 91 and a second part 92. The first part 90 includes a flange (not shown) that engages a groove 93 in the second part 92 when parts 91, 92 are put together as shown in FIG. 9(d). FIG. 9(b) shows switches 94, 95 in a standby or initial condition in which switches 94, 95 are closed. In the closed position, the free end of switch 94 makes contact with the conductive segments of detuning loop 96, while the free end of switch 95 closes a circuit bridging a tap point on antenna coil 97 and one end of antenna coil 97 (not unlike the embodiment described with reference to FIG. 3). The standby or initial condition is associated with a detuned tag 90 and with separated parts 91, 92.

When parts 91, 92 are put together as shown in FIG. 9(d), projecting parts 98, 99 associated with second part 92, engage and push up against switches 94, 95 causing the free end of switch 94 to break contact with the conductive segment of the detuning loop 96 and also causing the free end of switch 95 to break the circuit bridging between the tap point on antenna coil 97 and the one end of antenna coil 97. When switch 94 breaks contact with the conductive segment of the detuning loop, it also breaks a magnetic short that partially retunes the tag 90. Also, when switch 95 breaks the circuit bridging between the tap point on antenna coil 97 and the one end of antenna coil, it causes the tag 90 to be retuned by restoring the frequency of the tag to the read range of the interrogator.

Finally, it is to be understood that various alterations, modifications and/or additions may be introduced into the constructions and arrangements of parts previously described without departing from the spirit or ambit of the invention.

1. An RFID tag comprising:
at least one antenna;
a detuning loop including an open circuit electromagnetically coupled to said antenna; and
means for closing said open circuit, the tag being arranged such that when said circuit is closed said loop detunes the tag sufficiently to prevent it from being read.

2. An RFID tag according to claim 1 wherein said detuning loop includes an open circuit in two places.

3. An RFID tag according to claim 1 wherein said detuning loop includes a first switch for closing said open circuit to create a magnetic short.

4. An RFID tag according to claim 1 wherein said antenna and said detuning loop are located on a common substrate.

5. An RFID tag according to claim 4 wherein said detuning loop surrounds said antenna.

6. An RFID tag according to claim 3 wherein said first switch is biased to an open position.

7. An RFID tag according to claim 1 including means for adjusting inductance of said antenna.

8. An RFID tag according to claim 7 wherein said antenna includes a coil and said means for adjusting includes means for short circuiting at least some turns of said coil.

9. An RFID tag according to claim 8 wherein said means for short circuiting includes a second switch for connecting a tap point on said coil to one end of said coil.

10. An RFID tag according to claim 1 wherein when said open circuit is closed, the Q factor of a resonant circuit including said antenna is relatively low.

11. An RFID tag comprising:
at least one antenna;
a detuning loop including a closed circuit electromagnetically coupled to said antenna such that said loop detunes the tag sufficiently to prevent it from being read; and
means for opening said closed circuit to retune the tag.

12. An RFID tag according to claim 11 wherein said circuit includes a switch biased to a closed position and said means for opening said circuit includes means for moving said switch to an open position.

13. A method of detuning an RFID tag, said tag including at least one antenna, said method comprising:
providing a detuning loop including an open circuit such that said loop is electromagnetically coupled to said antenna; and
closing said open circuit such that said loop detunes said tag sufficiently to prevent it from being read.

14. A method according to claim 13 wherein said detuning loop includes an open circuit in two places.

15. A method according to claim 13 wherein said detuning loop includes a first switch for closing said open circuit to create a magnetic short.

16. A method according to claim 13 including providing said antenna and said detuning loop on a common substrate.

17. A method according to claim 13 wherein said detuning loop surrounds said antenna.

18. A method according to claim 15 wherein said first switch is biased to an open position.

19. A method according to claim 13 including the step of adjusting inductance of said antenna.

20. A method according to claim 19 wherein said antenna includes a coil and said step of adjusting includes short circuiting at least some turns of said coil.

21. A method according to claim 20 wherein said short circuiting is performed by connecting a tap point on said coil to one end of said coil.

22. A method of retuning an RFID tag, said tag including at least one antenna and a detuning loop including a closed circuit that is electromagnetically coupled to said antenna such that said loop detunes said tag sufficiently to prevent it from being read, said method comprising a step of opening said closed circuit to retune the tag.

23. A method according to claim 22 wherein said circuit includes a switch biased to a closed position and said step of opening said circuit includes moving said switch to an open position.
